(19) United States
(12) Patent Application Publication
(10) Pub. No.: US 2009/0050769 A1
(43) Pub. Date: Feb. 26, 2009

(54) FLAT DISPLAY SUPPORTING APPARATUS

(75) Inventor: Mamoru Goda, Osaka (JP)

Correspondence Address: DUANE MORRIS LLP - Philadelphia;IP DEPARTMENT, 30 SOUTH 17TH STREET, PHILADELPHIA, PA, 19103-4196, US

(73) Assignee: BELLTEC COMPANY, LIMITED, Osaka (JP)

(21) Appl. No.: 11/933,921

(22) Filed: Nov. 1, 2007

(30) Foreign Application Priority Data
Aug. 20, 2007 (JP) 2007213531

(51) Int. Cl. A47G 29/00; F16M 11/22

(52) U.S. Cl. 248/346.01

(57) ABSTRACT

A flat display supporting apparatus includes a main unit (2) of generally parallelepiped shape. A flat display (4) is placed on a top surface (2a) of the main unit (2) with its front and rear surfaces being in parallel with two opposing longitudinal surfaces (2b, 2c) of the main unit (2), respectively. Front and rear foldable units (8, 10) are disposed in front of the longitudinal surface (2b) and in the rear of the longitudinal surface (2c), respectively. Projections (12, 14) extend from the main unit (2) toward the foldable units (8, 10) and contact with lateral sides of the foldable units (8, 10). Rotation shafts (20, 22) extend from the lateral sides of the foldable units (8, 10) toward the projections (12, 14), and enter into shaft holes (16, 18) formed in the projections (12, 14), respectively. The shaft holes (16, 18) are provided with stops for preventing the foldable units (8, 10) from rotating to an angle larger than about 90 degrees with respect to the front and rear surfaces of the flat display (4), respectively.

### TECHNICAL FIELD

This invention relates to a supporting apparatus for supporting a flat display, e.g. a liquid crystal display and a plasma display, and, more particularly, to such supporting apparatus that is foldable.

### BACKGROUND ART

An example of such foldable supporting apparatus is shown in JP 2000-56695 A. The supporting apparatus disclosed in this publication includes a pillar-shaped main stand on which a thin display can be placed, and front and rear stands provided beneath the main stand. The front and rear stands can be positioned perpendicular to the front and rear surfaces of the main stand so that they can form an upside-down T shape with the main stand. The thickness of each of the front and rear stands is one-half the dimension measured between the front and rear surfaces of the main stand so that, when the front and rear stands are placed in contact with each other in the front-to-rear direction beneath the main stand, they can be vertically in alignment with the main stand. The front and rear stands can be turned forward and rearward, respectively, to form the upside-down T shape with the main stand, as described above.

Since the front and rear stands of this supporting apparatus can assume either the position where they are vertically aligned with the main stand or the position where they are perpendicular to the main stand, a thin display can be placed on, for example, a desk with the front and rear stands disposed perpendicular to the main stand. When the thin display is to be disposed on, for example, a wall, the front and rear stands are disposed in alignment with the main stand. Thus, with the supporting apparatus according to JP 2000-56695, a thin display can be disposed on either a desk or a wall. In addition, the width of a packaging case for the supporting apparatus can be smaller by packaging the supporting apparatus with the main, front and rear stands aligned.

### Problem to be Solved by the Invention

On the other hand, when the supporting apparatus with the front and rear stands aligned with the main stand is packaged, the dimension measured from the lower end of the front and rear stands to the top edge of the thin display mounted on the main stand is larger than the dimension measured with the front and rear stands disposed perpendicular to the main stand. This causes the number of the packages which can be shipped to be reduced.

An object of the present invention is to provide a flat display supporting apparatus for supporting a flat display, e.g. thin display, which can reduce not only the depth of the package (i.e. the dimension in the front-to-rear direction of the thin display) but also the height of the package.

### Means to Solve the Problem

A flat display supporting apparatus according to a first embodiment of the present invention has a main unit, which has a generally rectangular parallelepiped shape. The main unit has a top surface on which a flat display is adapted to be placed with the front and rear surfaces of the display being substantially in parallel with the opposing longitudinal surfaces of the main unit. The main unit is formed in such a shape that the distance between the opposing longitudinal surfaces thereof is larger than the thickness of the flat display. The flat display may be, for example, a liquid crystal display and a plasma display. A foldable unit is disposed to face at least one of the opposing longitudinal surfaces of the main unit. The foldable unit is adapted to face the corresponding one of the front and rear surfaces of the flat display and is generally in parallel therewith. A plurality of such foldable units may be provided to face both of the opposing longitudinal surfaces of the main unit, or a plurality of such foldable units may be provided at locations spaced along the length of one or both of the opposing longitudinal surfaces of the main unit. Projections extend from the main unit in such a manner that they can substantially contact the side surfaces of the foldable unit. Substantially horizontal rotation shafts extend either from the side surfaces of the foldable unit or the projections, toward the other. Rotation shaft receiving holes are formed in the other of the side surfaces of the foldable unit and the projections in such a manner that the rotation shafts can be rotatably received in the holes. The shaft receiving holes each are provided with a stop for preventing the foldable unit from assuming an angle larger than about ninety (90) degrees with respect to the associated one of the front and rear surfaces of the flat display. A second stop may be provided in each of the rotation shaft receiving holes in order to keep the foldable unit in a position where it faces substantially in parallel with the front or rear surface of the flat display.

With the described arrangement of the supporting apparatus, the foldable unit can be in a position where it faces substantially in parallel with the front or rear surface of the flat display when the supporting apparatus with the flat display supported thereon is packaged, and therefore the depth of a case in which the supporting apparatus with the flat display supported thereon is to be packaged, i.e. the dimension of the case in the front-to-rear direction of the flat display, can smaller than depth necessary for packaging a supporting apparatus with a foldable unit kept in a position where it is generally perpendicular to a front or rear surface of a flat display. Further, the height of the packaging case can be the dimension measured from the bottom of the main unit to the top of the flat display. Thus, a smaller packaging case can be used.

After being taken out of the packaging case, the foldable unit is rotated about the rotation shafts in a direction away from the flat display to a position where the foldable unit is substantially perpendicular to the front or rear surface of the flat display, and the stops in the rotation shaft receiving holes prevent the foldable unit from rotating further so that the foldable unit is kept perpendicular to the flat display.

The rotation shafts may be provided with a lower surface, which lies substantially horizontally when the foldable unit is in the position where it is substantially perpendicular to the front or rear surface of the flat display. In this case, the stops in the rotation shaft receiving holes are formed to contact a portion of the lower surfaces of the rotation shafts. Also, the second stops may be generally vertical surfaces formed in the inner surfaces of the shaft receiving holes, with which upper surfaces formed on the rotation shafts opposite to the lower surfaces can contact when the foldable unit is in the position where it faces substantially in parallel with the front or rear surface of the flat display.

In the above-described embodiment or in an embodiment same as the above-described one with the stops removed therefrom, the foldable unit may be disposed with a spacing from the main unit. In this case, the shaft receiving holes are extended generally horizontally toward the main unit, and an engaging member and a retaining member are provided in the opposing surfaces of the foldable unit and the main unit. The engaging and retaining members are adapted to engage with each other when the foldable unit in the position where it is generally perpendicular to the front or rear surface of the is flat display is moved toward the main unit.

With this arrangement, when the foldable unit is moved toward the main unit, the engaging and retaining members engage with each other, whereby the foldable unit can be held in the position where it is generally perpendicular to the front or rear surface of the flat display.

The engaging member may be an engaging projection projecting from one of the opposing surfaces of the foldable and main units toward the other. In this case, the retaining member is provided in the other of these surfaces. The retaining member pressingly holds the engaging member. The retaining member may be biased by, for example, elastic means, in the direction to sandwich or clamp the engaging member.

In the above-described embodiment or in an embodiment same as the above-described one with the stops removed therefrom, a projection may be provided in one of the opposing surfaces of the foldable and main units in such a manner as to extend toward the other. An opening is formed in the other of these surfaces in such a manner that the projection can extend into the opening when the foldable unit is moved toward the main unit to bring the opposing surfaces in contact with each other.

With this arrangement, when the foldable unit is in the position where it is perpendicular to the front or rear surface of the main unit, the projection formed on one of the foldable and main units extends into the other, and therefore the perpendicular position of the foldable unit with respect to the front or rear surface of the main unit can be more securely maintained.

A flat display supporting apparatus according to a second embodiment of the invention has a base unit on which a flat display is mounted. The base unit has a generally rectangular shape in plan. Two feet are disposed at respective ones of opposing ends of the base unit. The feet are mounted to the base unit at intermediate portions thereof in such a manner as to be rotatable about associated vertical shafts.

The feet are freely movable between a position where they are generally perpendicular to the base unit and a position where their length direction is aligned with that of the base unit. A flat display can be mounted on the base unit with the front and rear surfaces thereof being along the length direction of the base unit. When the supporting apparatus arranged as described above with a flat display mounted to the base unit in the described manner is packaged in a case, the feet are placed in the position where they are generally in alignment with the base unit. This makes it possible to use a packaging case having a reduced depth (i.e. a reduced dimension in the front-to-rear direction of the flat display), and a height equal to the distance between the top of the flat display and the bottom surfaces of the feet. Thus, the packaging cases can be down-sized.

The locations where the vertical shafts are disposed may be determined such that, when the feet are in alignment with the base unit, the length of the portions of the feet extending beyond the respective ends of the base unit is smaller than the length of the portions beneath the base unit.

With this arrangement, since it is possible to employ a small amount of extension of each foot beyond the ends of the base unit, the width of the packaging case can be small.

Projections may be provided either on the base unit or the pair of feet, and recesses, into which the projections can extend, are formed in the other. The recesses may be through-holes or simply be recesses receiving the projections. The projections are located on circles having their centers located at the vertical shafts, about which the feet are adapted to rotate. The recesses are formed at such locations that the projections can enter into the recesses when the feet are disposed in the position where they are perpendicular to the base unit.

When the feet are disposed perpendicular to the base unit, the respective projections enter into the associated recesses, so that the perpendicular positions of the feet can be maintained.

A flat display supporting apparatus according to a third embodiment of the invention has at least two mounts disposed, side by side along the width direction of a flat display, on the bottom surface of the flat display. The flat display may be, for example, a liquid crystal display or plasma display. The mounts are coupled to the flat display. The mounts may be coupled to the bottom surface of the flat display, to a portion within the display, or to the rear surface of the display. At least two supporting feet are mounted to the bottom surfaces of the respective mounts in such a manner as to be rotatable about respective shafts extending along the height direction of the flat display. The length of each supporting foot is equal to or less than one-half of the horizontal dimension or width of the flat display, but larger than the dimension of the flat display measured in the front-to-rear direction, i.e. the depth of the flat display. Thus, when the supporting feet are disposed such that their length direction extends in the horizontal direction of the flat display, the supporting feet neither protrude beyond the opposing ends of the flat display nor beyond the front and rear surfaces of the flat display. Also, the supporting feet have a predetermined width, which is equal to or less than the depth or the front-rear dimension of the flat display.

With this arrangement, when the supporting feet of the supporting apparatus are disposed to have their length extending in the width direction of the flat display, the feet protrude beyond neither the opposing lateral end surfaces nor front and rear surfaces of the flat display. By rotating the supporting feet in this position by about 90 degrees, the end portions of the respective feet protrude beyond the front and rear surfaces of the display so that the flat display can be supported stable. Since the mounts are discrete parts, they can be used with flat displays of various sizes to support the flat displays stable.

The supporting feet may be provided with rotation limiting means to limit the rotation of the feet within a range from and to the position where they extend along the width direction of the flat display and to and from the position where they extend along the depth direction of the flat display. With this arrangement, the supporting feet can rotate by only about 90 degrees, and therefore it is possible to support the flat display stable by simply rotating the supporting feet until they are stopped by the rotation limiting means.

A flat display supporting apparatus according to a fourth embodiment has a mount disposed on the bottom surface of a flat display. The number of the mounts may be ones or a plurality of such mounts may be disposed at locations along the width direction of the flat display. At least two supporting feet are attached to the bottom surface of each mount at opposite lateral ends thereof. The supporting feet are rotatable about respective shafts extending in the height direction of the flat display. The length of each supporting foot is equal to or less than one-half of the width or lateral dimension of the flat display, so that, when the supporting feet are disposed with their length direction aligned with the width direction of the flat display, the feet do not extend beyond the opposite lateral end surfaces of the flat display. Further, the width of each supporting foot is equal to or less than one half of the depth dimension (i.e. the distance between the front and rear surfaces) of the flat display.

With this arrangement, when the supporting feet are placed to extend along the lateral direction of the flat display, they do not protrude beyond the lateral sides of the flat display. Also, with the supporting feet held in this position, they do not protrude beyond the front and rear surfaces of the flat display. Further, since the flat display is supported by at least four supporting feet, it is supported stable securely.

### BRIEF DESCRIPTION OF THE DRAWINGS

FIG. 1 is a perspective view of a flat display supporting apparatus according to a first embodiment in an unfolded position.

FIG. 2 is a transverse cross-sectional view of the supporting apparatus shown in FIG. 1.

FIG. 3 is a front view of the supporting apparatus shown in FIG. 1.

FIG. 4A is an enlarged side view of a part of the supporting apparatus shown in FIG. 1, and FIG. 4B is a side view of the supporting apparatus shown in FIG. 1.

FIGS. 5A, 5B, 5C and 5D show the process in which the supporting apparatus of FIG. 1 in a folded position is unfolded.

FIGS. 6A and 6B are perspective views of a flat display supporting apparatus according to a second embodiment of the invention, showing feet of the supporting apparatus which are in alignment with a base unit, and the feet which are rotated to a position where they are perpendicular to the base unit, respectively.

FIG. 7 is a plan view of the supporting apparatus in the position shown in FIG. 6B.

FIG. 8 is a cross-sectional view along a line 8-8 in FIG. 7.

FIG. 9 is a cross-sectional view along a line 9-9 in FIG. 7.

FIGS. 10A and 10B are perspective views of a flat display supporting apparatus according to a third embodiment of the invention, showing supporting feet in closed and opened positions, respectively.

FIG. 11A is a perspective view of one of the supporting feet of the supporting apparatus shown in FIG. 10, FIG. 11B is a side view of a mount of the supporting apparatus shown in FIG. 10, and FIG. 11C is a perspective view of one of the supporting feet mounted on the mount.

FIG. 12 is a cross-sectional view along a line 12-12 in FIG. 11C.

FIG. 13A is a perspective view of an example of the supporting apparatus of FIG. 10, to which a fixer is attached, and FIG. 13B is a side view of an example of the supporting apparatus with the fixer shown in FIG. 11A, which is fixed to a flat display.

FIG. 14A is a perspective view of another example of a fixer attached to the supporting apparatus shown in FIG. 10, and FIG. 14B is a perspective view of the fixer of FIG. 14A illustrating an example of the manner of fixing the fixer to a flat display.

FIG. 15 is a perspective view of a flat display supporting apparatus according to a fourth embodiment of the invention, on which a flat display is mounted, with supporting feet of the supporting apparatus opened.

FIG. 16 is a front view of part of the flat display on the supporting apparatus shown in FIG. 15.

FIG. 17 is a bottom plan view of the supporting apparatus shown in FIG. 15.

FIG. 18 is a partially broken-away cross-sectional view of the supporting apparatus shown in FIG. 15.

### BEST MODE FOR CARRYING OUT THE INVENTION

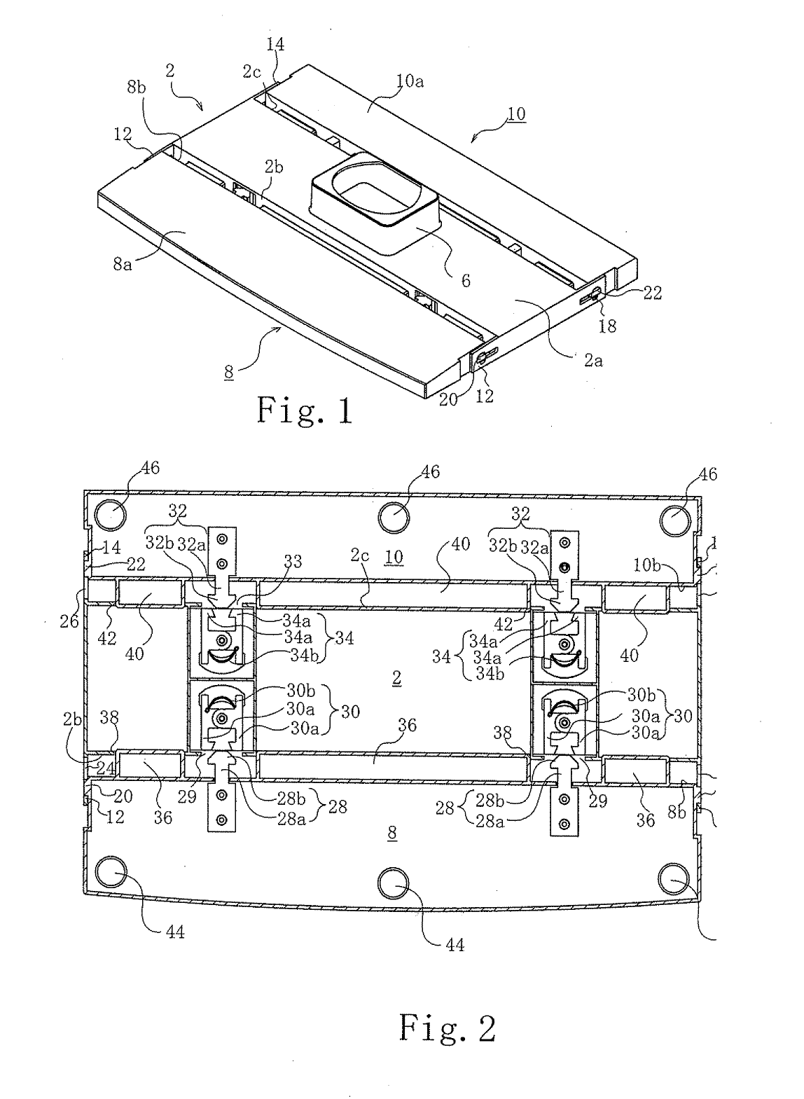

As shown in FIG. 1, a flat display supporting apparatus according to a first embodiment of the present invention has a main unit 2. The main unit 2 may be formed to have, for example, a flat rectangular parallelepiped shape. A stand 6 is formed in the center of the top surface 2a of the main unit 2, and a flat display, for example, a liquid crystal display 4 is adapted to be mounted on the stand 6. The liquid crystal device 4 is mounted on the stand 6 in such a manner that its front surface can be located on the side on which a longitudinal surface 2b of the main unit 2 is located, with the rear surface located on the same side as a longitudinal surface 2c of the main unit 2, and with the front and rear surfaces being in parallel with the longitudinal surfaces 2b and 2c of the main unit 2. The longitudinal surfaces 2b and 2c of the main unit 2 are opposing to and in parallel with each other. Hereinafter, the longitudinal surfaces 2b and 2c are sometimes referred to as front and rear longitudinal surfaces 2b and 2c, respectively.

A foldable unit, e.g. front foldable unit 8, is disposed to face the front longitudinal surface 2b of the main unit 2, and another foldable unit, e.g. rear foldable unit 10, is disposed to face the rear longitudinal surface 2c of the main unit 2. The front and rear foldable units 8 and 10 have a generally flat rectangular parallelepiped shape, as the main unit 2. It should be noted that the top surface of the front foldable unit 8 is slightly slanting downward in the forward direction, i.e. the height of the edge portion near the main unit is largest, and decreases toward the other edge. On the other hand, the top surface 10a of the rear foldable unit 10 is horizontal, as the top surface 2a of the main unit 2. The length and height of the front and rear foldable units 8 and 10 are generally equal to the length and height of the main unit 2. The depth of the foldable units 8 and 10 is smaller than that of the main unit 2. The main unit 2, the front foldable unit 8 and the rear foldable unit 10 may be formed of, for example, synthetic resin.

As shown in FIGS. 1 and 2, a rear surface 8b of the front foldable unit 8 is spaced from the front longitudinal surface 2b of the main unit 2 by a predetermined distance. Similarly, a front surface 10b of the rear foldable unit 10 is spaced from the rear longitudinal surface 2c of the main unit 2 by the same predetermined distance.

Projections 12, 12 extend from the lateral ends of the front longitudinal surface 2b toward and in contact with the lateral side surfaces of the front foldable unit 8. Similarly, projections 14, 14 extend from the lateral ends of the rear longitudinal surface 2c toward and in contact with the lateral side surfaces of the rear foldable unit 10. Shaft holes 16, 16 and 18, 18 are formed in the projections 12 and 14, respectively.

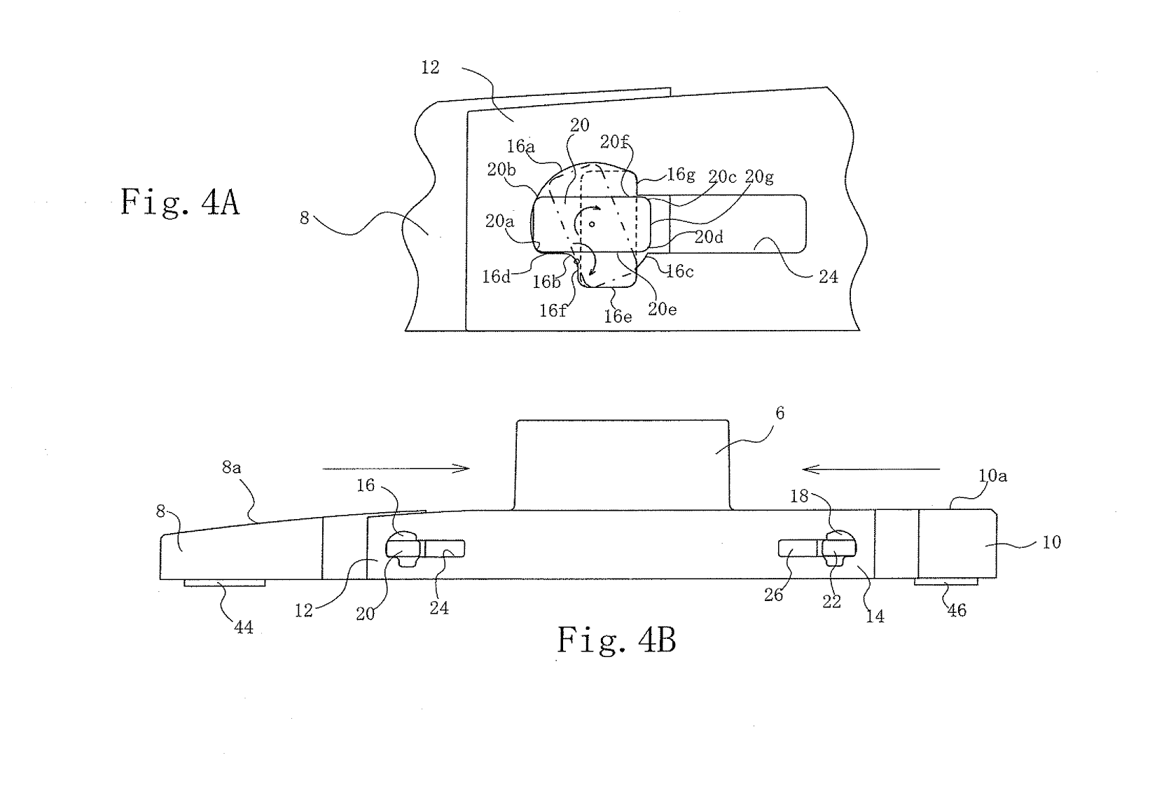

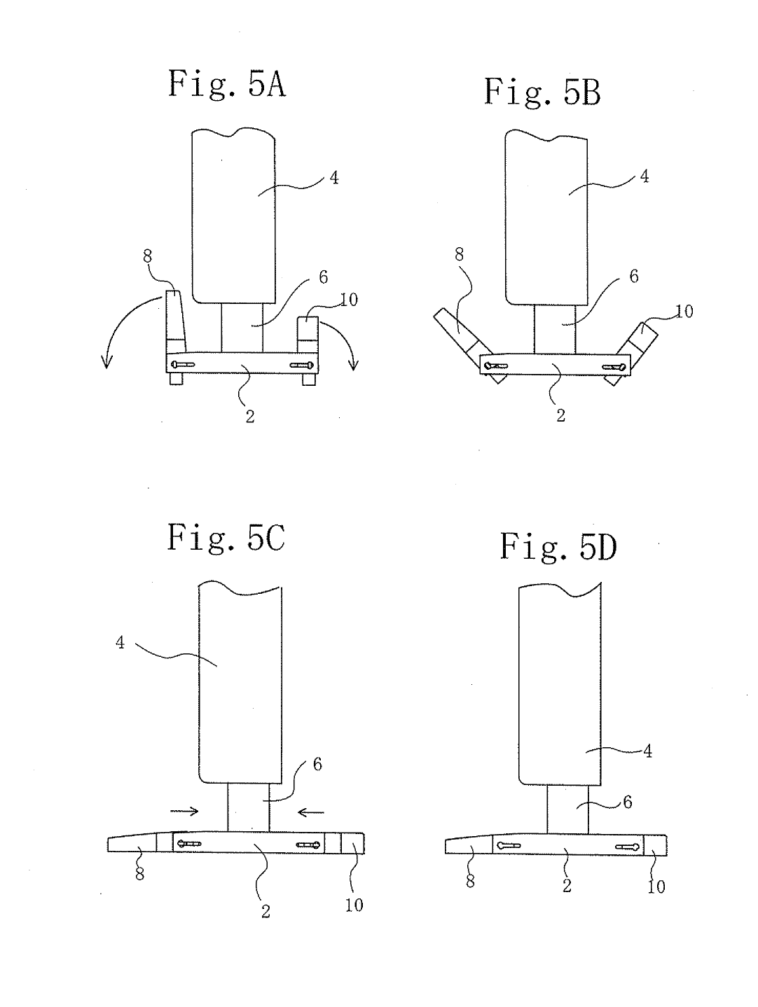

Rotation shafts 20 and 22, which substantially perpendicularly extend from the side surfaces of the front and rear foldable units 8 and 10, respectively, are inserted into the corresponding shaft holes 16 and 18, as is seen from FIGS. 4A and 4B. As shown in FIG. 4A, in which one of the rotation shafts 20 is shown as a representative of the four rotation shafts 20 and 22, each rotation shaft 20 is in the form of a short rectangular parallelepiped, and the respective four corners are rounded into rounded corners 20a, 20b, 20c and 20d. Each of the rotation shafts 22 is similarly formed. The shaft holes 16 and 18 are formed in the shape shown in FIG. 4A, for example, so that the front and rear foldable units 8 and 10 can be rotated upward from a position, or unfolded position, where they are perpendicular to the front and rear surfaces of the liquid crystal display 4 as illustrated in, for example, FIGS. 5D and 4B, to a folded position where the top surfaces 8a and 10a of the front and rear foldable units 8 and 10 are generally in parallel with the front and rear surfaces of the liquid crystal display 4 as illustrated in FIG. 5A, and also can be rotated downward from the folded position to the unfolded position.

Specifically, as shown in FIG. 4A, each shaft hole 16 has curved surfaces 16a, 16b and 16c, and stops, e.g. horizontally extending stop surfaces 16d and 16e, and vertically extending stop surfaces 16f and 16g. The curved surface 16a curves upward from a front, lower portion of the shaft hole 16 toward the main unit 2, the horizontal stop surface 16d extends rearward from the lower end of the curved surface 16a, the curved surface 16b extend downward from the rear end of the horizontal stop surface 16d, the vertical stop surface 16f connects to the curved surface 16b and extends downward, the horizontal stop surface 16e connects to the vertical stop surface 16f and extends toward the main unit 2, and the vertical stop surface 16g extending upward connects to the horizontal stop surface 16e. The curved surface 16c extends upward toward the main unit 2 from an intermediate point on the vertical stop surface 16g.

In the unfolded position of the front foldable unit 8, the two, front-side rounded corners 20a and 20b are in contact with the curved surface 16a, and a portion of a lower surface 20e of the rotation shaft 20 is in contact with the horizontal stop surface 16d, so that the front foldable unit 8 is prevented from rotating further downward. When the front foldable unit 8 in this unfolded position is rotated upward toward the liquid crystal display 4, the rounded corners 20a and 20b are guided along the curved surface 16a to a position, indicated by a dot-dash line in FIG. 4A, where the lower surface 20e of the rotation shaft 20 contacts with the curved surface 16b. After that, the surface 20e of the rotating shaft 20 is guided along the curved surface 16b, and the rotation shaft 20 rotates to a position indicated by a broken line. In this way, the front foldable unit 8 is placed in the folded position. In the folded position, the upper surface 20f of the rotation shaft 20 is in contact with the vertical stop surface 16g, and the rear surface 20g of the rotation shaft 20 is in contact with the horizontal stop surface 16e. Also, the lower surface 20e of the rotation shaft 20 can contact with the vertical stop surface 16f. Accordingly, the foldable unit 8 is prevented from further rotating toward the liquid crystal display 4.

The foldable unit 8 rotates from the folded position to the unfolded position in the direction opposite to the above-described direction. In this case, the curved surface 16c guides the rear-side rounded corner 20c of the rotation shaft 20. In this position changing procedure, the front foldable unit 8 does not rotate from its folded position to the unfolded position in a single stroke, and therefore there is no fear that an operator may have his or her hand or fingers caught between the foldable unit 8 and the surface on which the flat display supporting apparatus is installed.

The shaft holes 18 and the rotation shafts 22 of the rear foldable unit 10 and the shaft holes 16 and the rotation shafts 20 of the front foldable unit 8 are in line symmetry with respect to a vertical line extending through the main unit 2 being the axis of symmetry. Thus, the movements of the rear foldable unit 10 from and to its unfolded position to and from its folded position take place in a manner similar to the front foldable unit 8. Accordingly, no detailed description of the folding and unfolding operation of the rear foldable unit 10 is given.

An elongated hole 24 is formed to horizontally extend from an intermediate portion of the vertical stop surface 16c of the shaft hole 16 in each of the projections 12 in such a manner as to be permit the front foldable unit 8 in the above-described unfolded position to slide toward the main unit 2 so that the rear surface 8b can contact with the front longitudinal surface 2b of the main unit 2. Also, an elongated hole 26 is formed in each of the projections 14, and the elongated holes 24 and 26 are in line symmetry with respect to a vertical line extending through the elongated hole 24 and the main unit 2.

As shown in FIG. 2, engaging members 28, 28 are formed in the rear surface 8b of the front foldable unit 8 at locations spaced along the length direction of the front foldable unit 8. The engaging members 28 protrude toward the front longitudinal surface 2b of the main unit 2. Each of the engaging members 28 has a horizontally extending neck portion 28a and an enlarged portion 28b at the distal end of the neck portion 28a.

At locations on the front longitudinal surface 2b of the main unit 2 corresponding to the locations of the engaging members 28, openings 29, 29 are formed. Retaining members 30, 30 are disposed within the respective ones of the openings 29. Each retaining member 30 has clamping means, e.g. claws 30a, which clamps the joined portion of the engaging member 28 where the enlarged portion 28b connects to the neck portion 28a, from opposite sides. Biasing means, e.g. a spring 30b, gives force to the claws 30a to make them rotate toward each other. Thus, when the front foldable unit 8 is slid toward the main unit 2, the engaging members 28 enter into the main unit 2 through the openings 29 and open the closed claws 30a against the biasing force given by the springs 30b. As the front foldable unit 8 slides further toward the main unit 2, the claws 30a are closed due to the biasing force given by the springs 30b to thereby firmly clamp or hold the joined portions of the engaging members 28. In this manner, the foldable unit 8 is coupled to the main unit 2.

Engaging members 32 are disposed on the front surface 10b of the rear foldable unit 10. The engaging members 32 and the engaging members 28 are in line symmetry with respect to an axis of symmetry extending along the length of the main unit 2. The main unit 2 is provided with openings 33 and retaining members 34. The openings 33 and retaining members 34 of the rear foldable unit 10 and the openings 29 and retaining members 30 of the front foldable unit 8 are in line symmetry. Thus, when the rear foldable unit 10 is slid toward the main unit 2, the engaging members 32 are firmly caught by the retaining members 34, and the rear foldable unit 10 is coupled to the main unit 2.

Three protrusions 36 in a generally rectangular parallelepiped shape protrude, toward the front longitudinal surface 2b of the main unit 2, from those portions of the rear surface 8b of the front foldable unit 8 which are outward of the respective engaging members 28 and between the engaging members 28. Three openings 38 corresponding to the protrusions 36 are formed in the front longitudinal surface 2b of the main unit 2 in such a manner that, when, the front foldable unit 8 is slid toward the main unit 2, the protrusions 36 can enter into the corresponding openings 38. In this way, when the front foldable unit 8 is moved toward the main unit 2, the protrusions 36 enter into the main unit 2, to thereby enhance the mechanical strength of the coupling between the front foldable unit 8 and the main unit 2.

Three protrusions 40 are formed in the front surface 10b of the rear foldable unit 10 in such a manner that the protrusions 40 and the protrusions 36 can be in line symmetry. Also, three openings 42 are formed in the rear longitudinal surface 2c of the main unit 2 in such a manner that the openings 42 and the opening 38 are in line symmetry, whereby, when the rear foldable unit 10 is slid toward and coupled to the main unit 2, the protrusions 40 enter into the corresponding openings 42 to thereby enhance the mechanical strength of the coupling between the foldable unit 10 and the main unit 2.

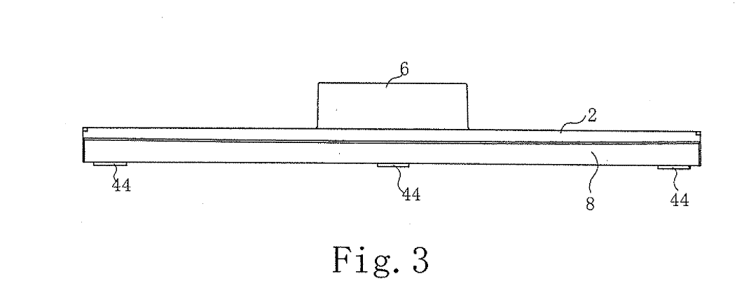

As shown in FIGS. 2 and 3, three short cylindrical feet 44 and three short cylindrical feet 46 are disposed on the bottom surfaces of the front and rear foldable units 8 and 10, respectively.

The flat display supporting apparatus having the above-described structure is packaged into a case with the front and rear foldable units 8 and 10 folded as shown in FIG. 5A. In this folded position, the upper surfaces of the rotation shafts 20 and 22 are in contact with the vertical stop surfaces 16c and 18c, respectively, and therefore it never happens that the front and rear foldable units 8 and 10 rotate further toward the liquid crystal display 4 from the folded position.

When the front and rear foldable units 8 and 10 in this folded position are rotated forward and rearward, respectively, they are moved, through the position shown in FIG. 5B, to the unfolded position shown in FIG. 5C. After that, the front and rear foldable units 8 and 10 are slid toward the main unit 2, and they are coupled firmly to the main unit 2.

When the front and rear foldable units 8 and 10 are in the folded position shown in FIG. 5A, they are facing the front and rear surfaces of the liquid crystal display 4. Therefore the folding of the foldable units 8 and 10 does not increase the total height of the supporting apparatus and the liquid crystal display 4 mounted thereon. In addition, by sliding the front and rear foldable units 8 and 10 in the unfolded position toward the main unit 2, the engaging members 28 and 32 are brought into engagement with the retaining members 30 and 34, respectively, so that the front and rear foldable units 8 and 10 are firmly coupled to the main unit, and the mechanical strength of the coupling is enhanced by the protrusions 36 and 40.

In the described embodiment, the rotation shafts 20 and 22 are formed on the front and rear foldable units 8 and 10, respectively, with the shaft holes 16 and 18 formed in the projections 12 and 14, respectively, but the rotation shafts 20 and 22 may be formed on the projections 12 and 14, respectively, with the shaft holes 16 and 18 formed on the front and rear foldable units 8 and 10, respectively. Also, the engaging members 28 and 32 may be formed on the main unit 2, with the retaining members 30 and 34 formed on the front and rear foldable units 8 and 10, respectively. In the described embodiment, the front and rear foldable units 8 and 10 are used, but either one of them only may be used. In stead of single front and rear foldable units 8 and 10, one or both of them may be divided along the length direction into plural foldable units. In this case, rotation shafts and shaft holes are provided for each of the resultant foldable units. Further, the shapes of the shaft holes 16 and 18 need not be as described, but any other shapes can be employed only if the rotation shafts 20 and 22 can be guided between the folded position and the unfolded position.

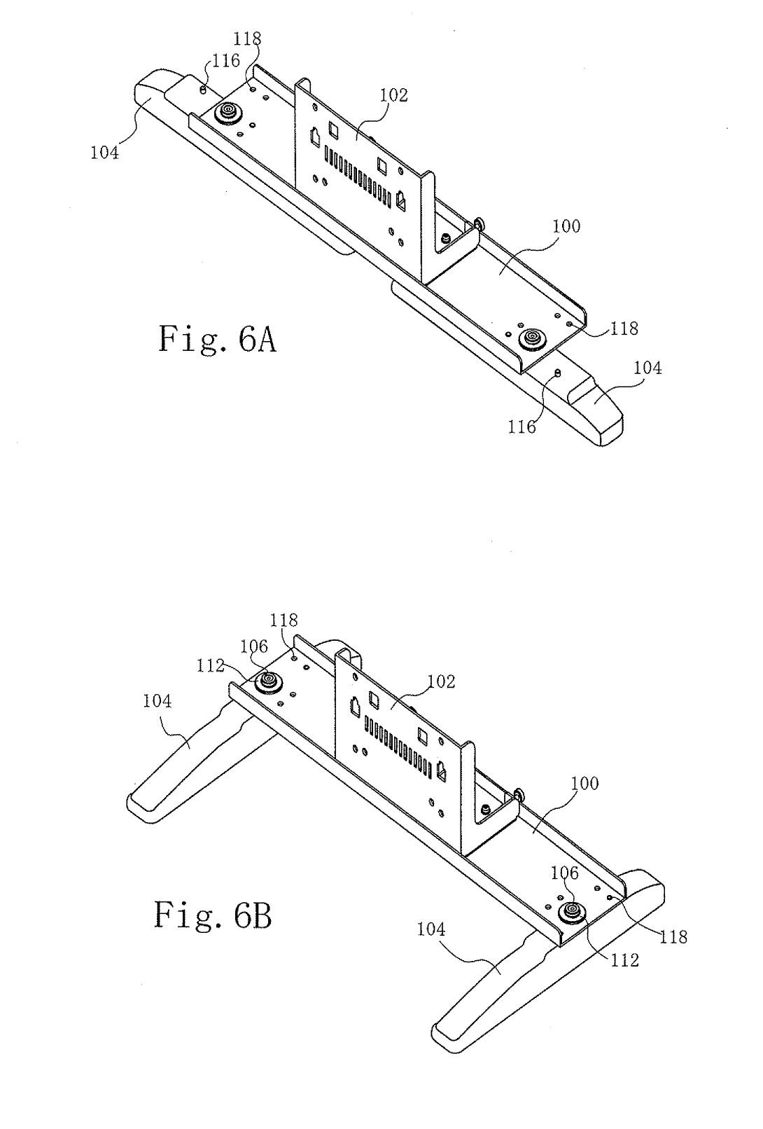

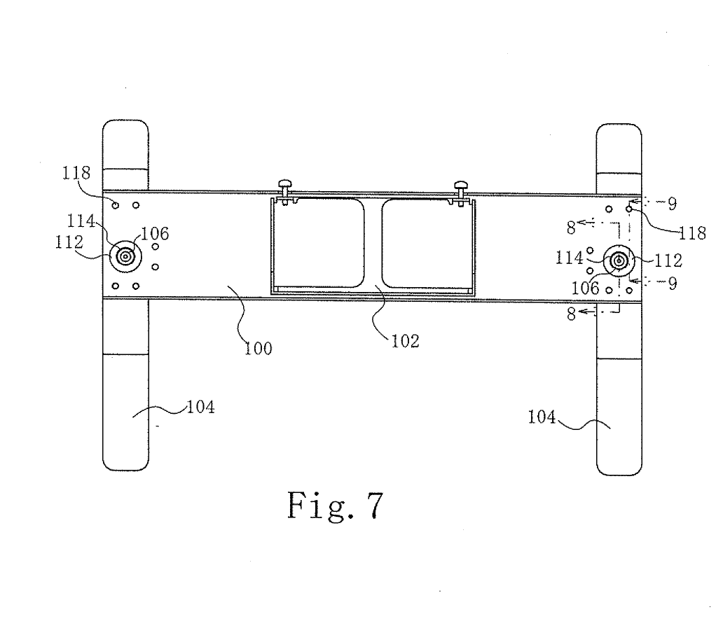

A flat display supporting apparatus according to a second embodiment of the present invention includes a base unit 100, as shown in FIGS. 6A, 6B and 7. The base unit 100 has a rectangular shape, for example, and has its opposing longitudinal edges turned upward. A bracket 102 for securely supporting or holding a flat display, e.g. a liquid crystal display (not shown), is fixed in a center portion of the top surface of the base unit 100.

Two feet 104 are mounted to the base unit 100 at locations near the respective opposing longitudinal ends of the base unit 100. The feet 104 are arranged to be moved between a position where the two feet 104 are aligned with the base unit 100 as shown in FIG. 6A and a position, shown in FIGS. 6B and 7, where the two feet 104 are generally perpendicular to the base unit 100.

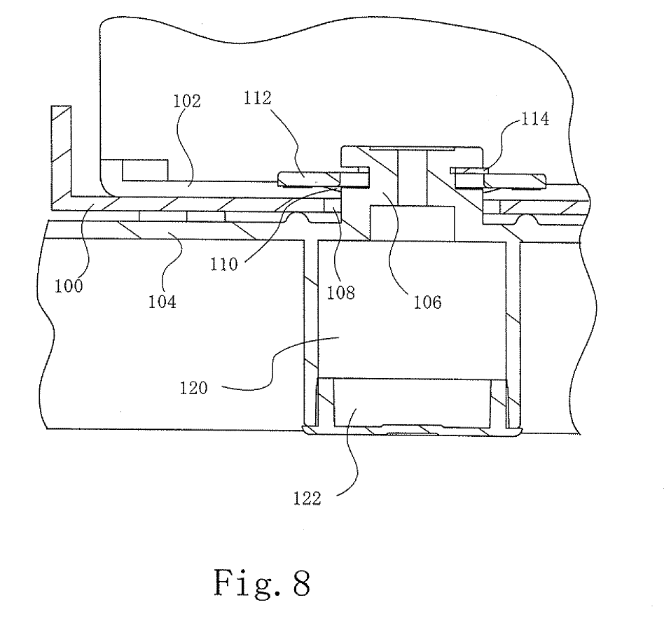

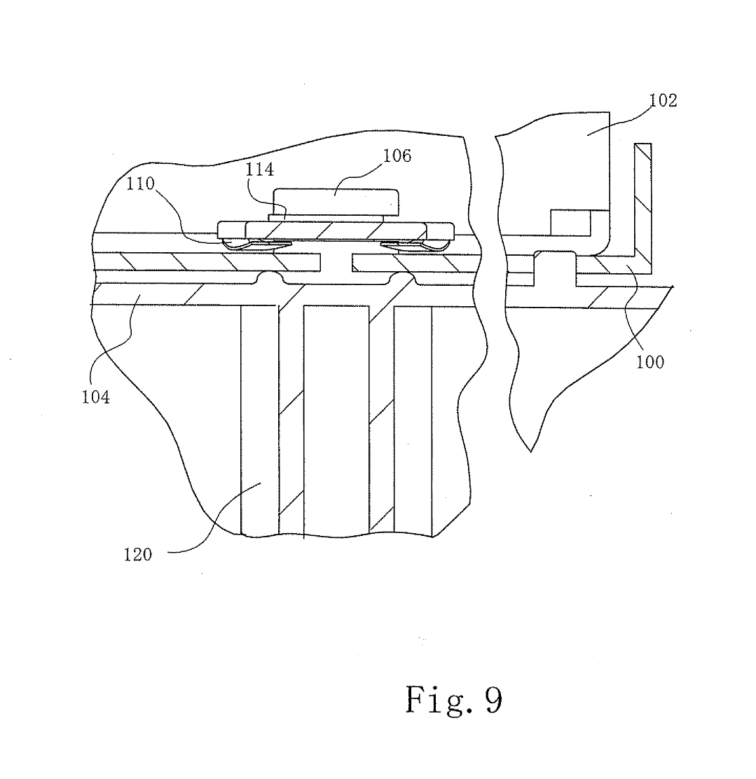

Specifically, as shown being enlarged in FIG. 8, a shaft 106 protrudes vertically upward from the top surface of each foot 104. The shafts 106 extend through respective openings 108 formed through the longitudinal end portions of the base unit 100. A wavy washer 110 is fitted over each shaft 106 to contact with the top surface of the base unit 100, as shown in FIG. 9. A disc-shaped stopper 112 is also fitted over each shaft 106 in such a manner as to be in contact with the associated wavy washer 110. Each stopper 112 is fixed to the shaft 106 by means of an E-ring 114 in such a manner the stopper 112 presses the wavy washer 110 toward the base unit 100. Thus, the feet 104 are made rotatable about the associated shafts 106 by pressing the shafts 106 downward, while holding the base unit 100, to thereby separate the feet 104 from the base unit 100.

The locations where the rotation shafts 106 are attached to the feet 104 are rather near to the ends of the respective feet 104, as shown in FIGS. 6A and 6B. This is because, when the feet 104 are placed in alignment with the base unit 100, the amount of outward protrusion of the feet 104 beyond the ends of the base unit 100 can be small.

As shown in FIG. 6A, which shows the position of the feet 104 in alignment with the base unit 100, engaging pins or protrusions 116 extend upward from the top surfaces of the portions of the respective feet 104 extending beyond the ends of the base unit 100. The locations where the engaging pins 116 are disposed are in point symmetry. Retention recesses, e.g. retention holes 118, are formed in opposing end portions of the base unit 100 at such locations that, when the feet 104 are rotated to the position where they are perpendicular to the base unit 100, the pins 116 can enter into the respective retention holes 118, whereby the feet 104 are fixed with respect to the base unit 100 in the perpendicular position. The release of the feet 104 from this fixed position can be effected by pressing the rotation shafts 106 downward, while holding the base unit 100.

Reinforcement members 120 for increasing the strength are disposed within the respective feet 104, as shown in FIG. 8, and lids 122 are attached to the lower ends of the respective reinforcement members 120.

When the flat display supporting apparatus with the liquid crystal display fixed to it is packaged in a case, the feet 104 are positioned in line with the base unit 100 as shown in FIG. 6A, so that the depth of the case can be small. Also, since the locations of the shafts 106 about which the feet 4 are rotated are near the ends of the base unit 100 so that the amount of extension of the feet 104 beyond the ends of the base unit 100 can be small, the width of the packaging case can be minimized. This amount of extension may be smaller than the length of the remaining portions of the feet 104 lying underneath the base unit 100.

In this embodiment, the openings 108 are formed in the base unit 100 and the rotation shafts 106 are formed in the feet 104. However, the shafts 106 may be disposed on the base unit 100 with the openings 108 formed in the feet 104. Also, the engaging pins 116 may be on the base unit 100, and recesses, in place of the through-holes 118, into which the pins 116 can be enter, may be formed in the feet 104.

According to the described two embodiments, when the flat display supporting apparatus with a flat display mounted thereon is packaged in a case, the depth of the packaging case can be small. Further, the height of the case can be smaller than prior packaging cases, as previously described. Accordingly, the number of packaging cases to be shipped on trucks or transportation means can be increased.

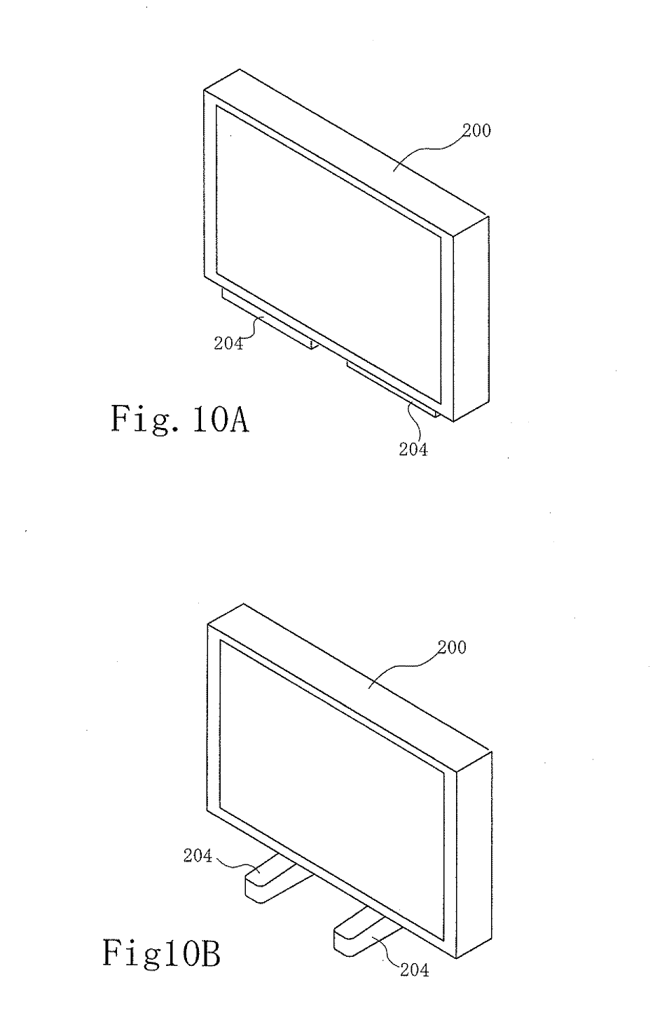

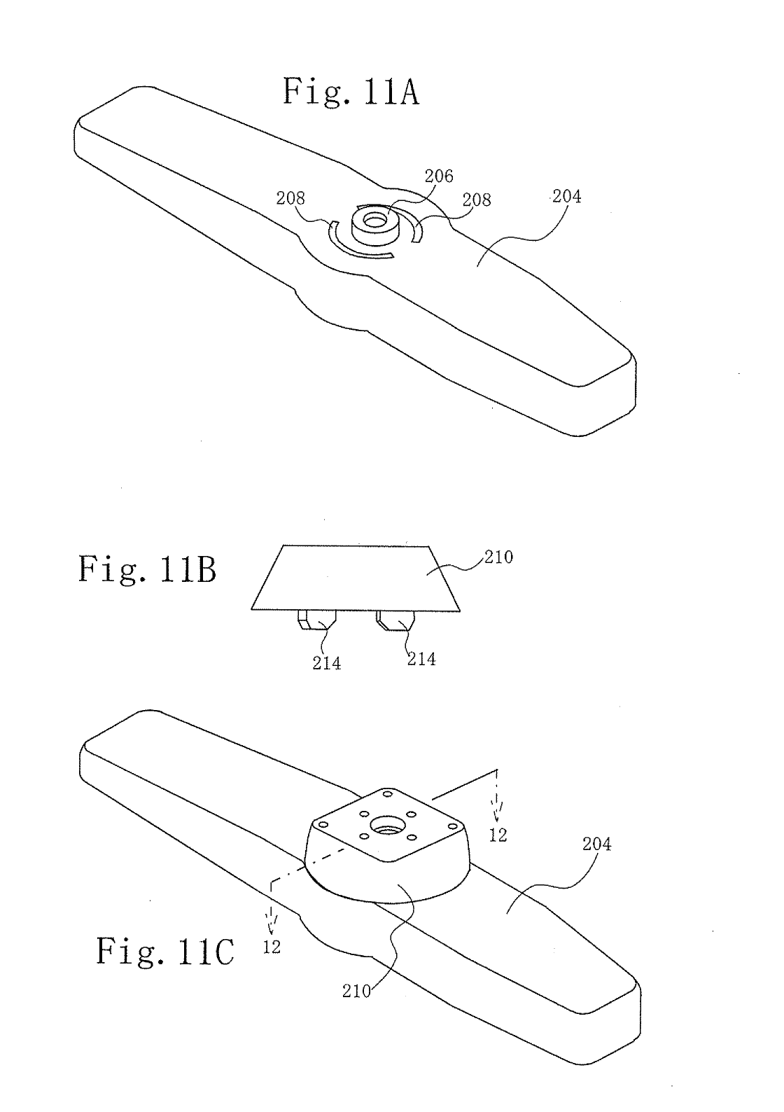

A flat display supporting apparatus according to a third embodiment of the present invention is disposed on the bottom surface of a flat display 200, as shown in FIGS. 10A and 10B. The supporting apparatus shown in FIGS. 10A and 10B has two supporting feet 204. As shown in FIG. 11A, each foot 204 is in the shape of generally flat rectangular parallelepiped. A shaft 206 protrudes upward at a location on the top surface of the foot 204 somewhat displaced from the center toward one end of the foot 204. Two arcuate grooves 208 are formed in the top surface of the foot 204 to surround the shaft 206. The grooves 208 are formed at diametrically opposite locations on a circle about the shaft 206, so that they are on opposite sides of the longitudinal axis of the foot 204 and, therefore, in point symmetry with each other. The central angle of the grooves 208 is somewhat larger than 90 degrees.

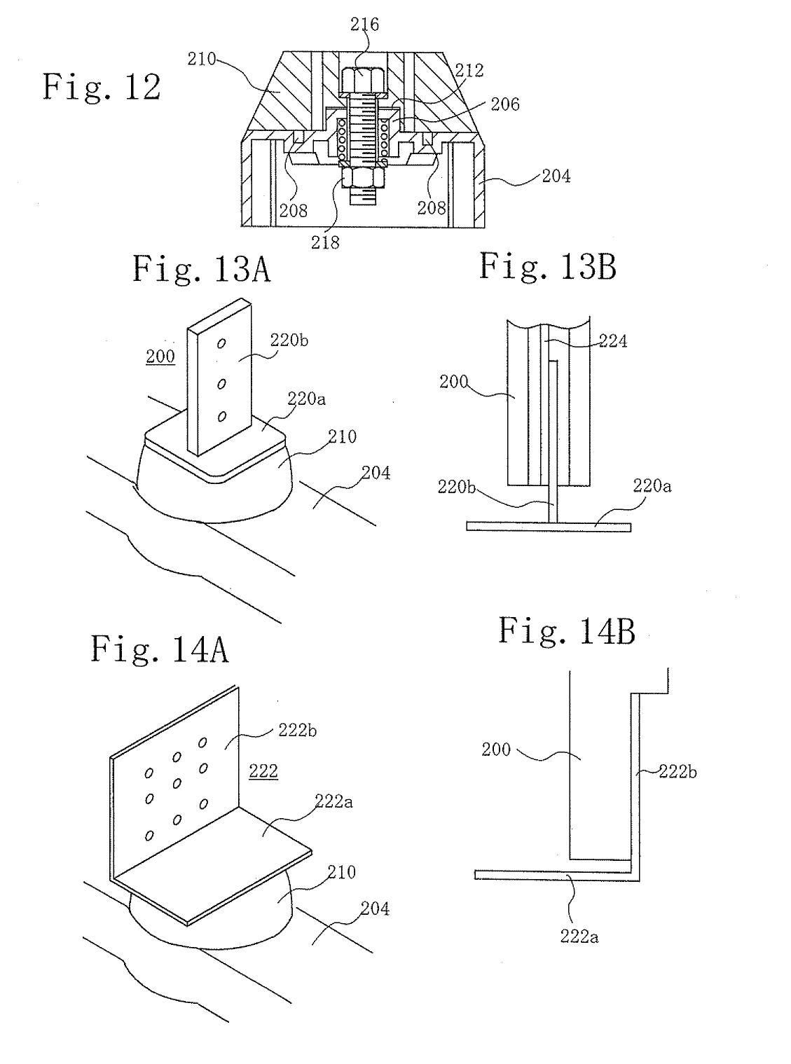

A mount 210 is attached to the shaft 206 of each supporting foot 204. The mount 210 has a frustum shape, as shown in FIG. 11B, and has a recess 212 at the center of the bottom surface, in which the shaft 206 is placed, as shown in FIG. 12. The mount 210 has protrusions 214 which are adapted to be placed in the grooves 208, as shown in FIG. 11B. The protrusions 214 are in point symmetry with respect to the center of the bottom surface of the mount 210. Accordingly, when one of the protrusions 214 is at one end of one of the grooves 208, the other protrusion 214 is at the diametrically opposite, other end of the other groove 208. As shown in FIGS. 11C and 12, the mount 212 has its recess 212 fitted over the shaft 206 of the supporting foot 204, and has the projections 214 inserted into the grooves 208. In this position, a bolt 216 is inserted from the top surface of the mount 212 into the interior of the foot 204, and is fixed by a nut 218. The foot 204 is rotatable about the bolt 216. The foot 204 can be rotated in one direction until one protrusion 214 contacts with one end of one groove 208, and in the other direction until the other protrusion 214 contacts with the end of the other groove 208 on the same side of the shaft 206 as the one end of the one groove 208.

A horizontal part 220a of a T-shaped fixing member 220, having a vertical part 220b, is mounted on top of the mount 210, for example, as shown in FIG. 13A. The vertical part 220b enters through the bottom surface of the flat display 200 into the interior of the flat display 200 and is secured to a shield plate 224 within the display 200, as shown in FIG. 13B.

Alternatively, a horizontal part 222a of a L-shaped fixing member 222, which also has a vertical part 222b erected upward from one end of the horizontal part 222a, may be mounted on top of the mount 210, as shown in FIG. 14A, The vertical part 222b is secured to the rear surface of the flat display 200, as shown in FIG. 14B.

Which of the fixing member 220 or 222 is to be used can be determined according to the specifications of the flat display 200. As described, the supporting apparatus according to the third embodiment is composed of two supporting devices, namely, the supporting feet 204 and the mounts 210 mounted on the respective feet 204, the flat display 200 of any size can be supported. On the other hand, if, for example, a supporting apparatus including two supporting devices connected with a coupling device is used with a large flat display, the two supporting devices support the flat display at closely spaced locations in the middle portion along the width of the flat display, and therefore the flat display is unstable. If the flat display is small in size, the two supporting devices support the flat display at rather remotely spaced locations on the flat display, and therefore the flat display supported is not good in appearance.

In contrast, the supporting apparatus according to this embodiment is composed of two supporting devices formed as separate components, and therefore the flat display of any size can be supported stable with an agreeable appearance.

The length of the feet 204 is such that, when the feet 204 are placed to have their length direction in alignment with the width direction of the flat display 200 as shown in FIG. 10A, the respective ends of the feet 204 do not extend beyond the associated lateral sides of the flat display 200. At the same time, in order to support the flat display 200 stably by aligning the length direction of each foot 204 with the depth direction of the flat display 200 as shown in FIG. 10B, the length of each foot 204 is equal to or less than one-half of the lateral dimension or width of the flat display 200, but equal to or larger than the depth of the flat display 200. The width of each foot 204, i.e. the dimension of each foot 204 in the depth direction of the flat display 200 in FIG. 10A, is equal to or smaller than the depth of the flat display 200 so that the longitudinal edges of the foot 204 do not extend beyond the front and rear surfaces of the flat display 200. However, the width of each foot 204 should be so determined as to be able to support the flat display 200 stably.

Since the feet 204 do not extend beyond the lateral sides of the flat display 200 when they are positioned with their length direction aligned with the width direction of the flat display 200, a packaging case, in which the supporting apparatus with the flat display 200 supported on the supporting apparatus is to be packaged, can have a width and a depth matching the ones of the flat display 200. Thus, it never occurs that the size of packaging cases is increased due to the supporting apparatus.

When the flat display 200 supported by the supporting apparatus is taken out of a packaging case, as shown in FIG. 10A, the supporting feet 204 are rotated by about 90 degrees about the associated bolts 216 to the position shown in FIG. 10B, the flat display 200 can be stably supported. The rotation of each foot 204 is limited by the protrusions 214 of the associated mount 210 abutting against the ends of the grooves 208, and therefore the rotation by about 90 degrees of the feet 204 is easily secured.

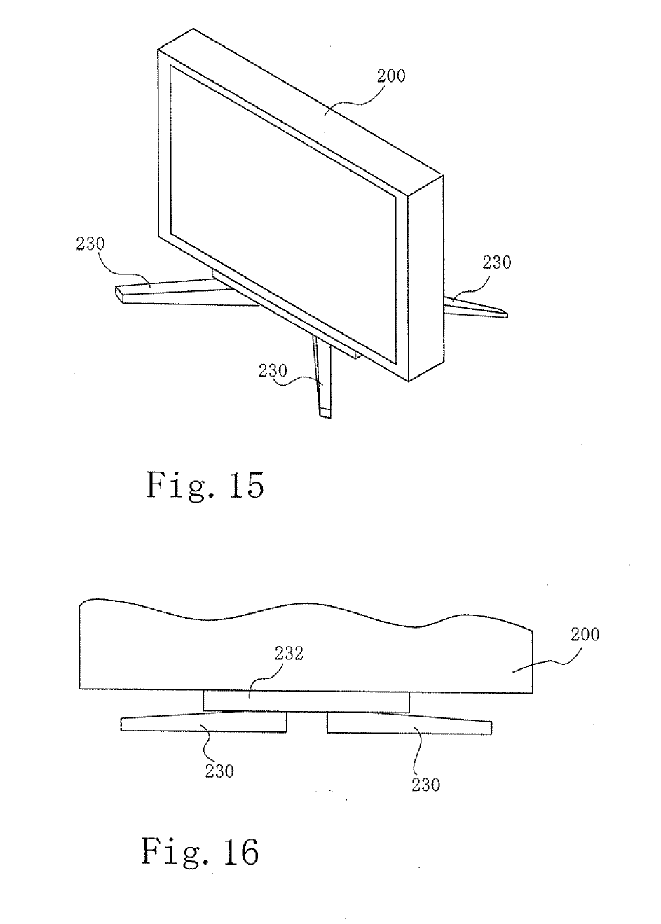

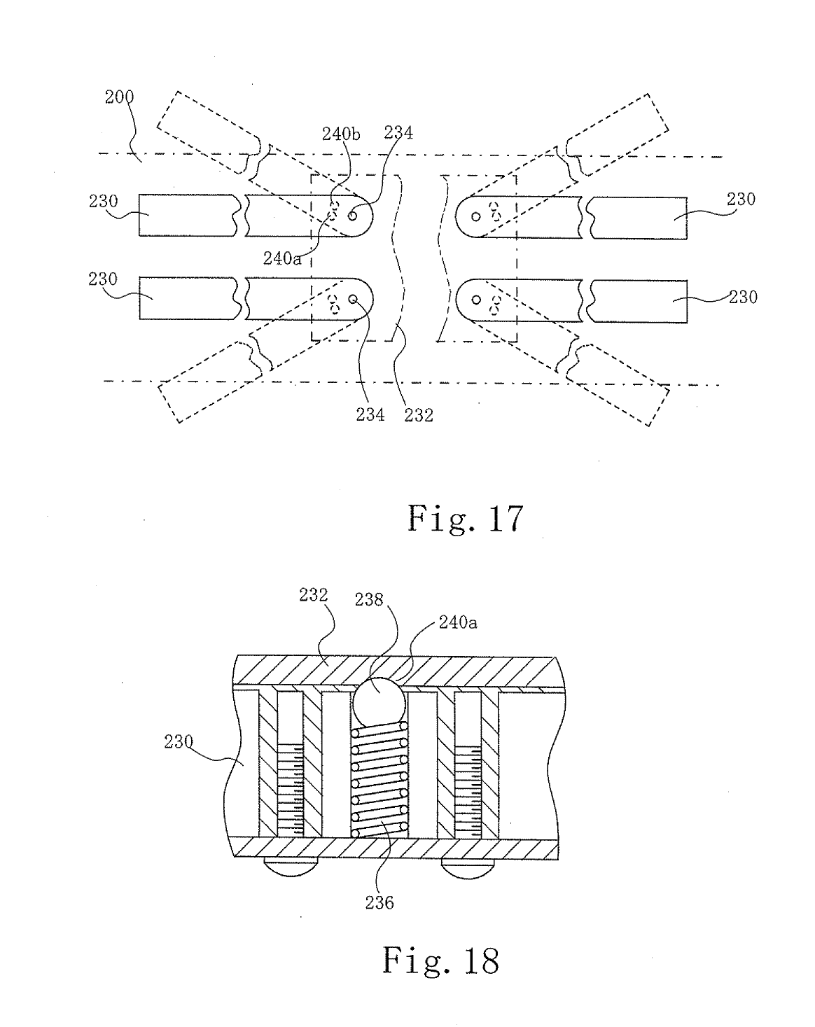

A flat display supporting apparatus according to a fourth embodiment of the invention supports a flat display 200 by means of four, in total, supporting feet 230, as shown in FIG. 15. The four supporting feet 230 are attached to a mount 232 mounted in the center portion of the bottom surface of the flat display 200, as is seen in FIG. 16. The mount 232 has a shape of flat rectangular parallelepiped. Two supporting feet 230 are attached to each of two opposing end portions of the bottom surface of the mount 230. (It should be noted that more than two feet may be attached to each end portions of the mount 230.) The two feet 230 are arranged in the depth direction of the flat display 200. Each supporting foot 230 has its one end attached to the mount 230 in such a manner as to be rotatable about an associated shaft 234 extending along the height direction of the flat display 200, as shown in FIG. 17. As will be understood from FIG. 17, each foot 230 has a length equal to or smaller than one-half of the width of the flat display 200, but equal to or larger than the depth of the flat display 200. Also, each foot 230 has a predetermined width, i.e. the dimension in the direction along the depth of the flat display 200 when the feet 230 are in the position shown in FIG. 17, which is equal to or smaller than one-half of the depth of the flat display 200. The respective feet 230 are disposed in such a manner that the distal ends thereof do not protrude beyond the corresponding lateral sides of the flat display 200 and that the longitudinal sides thereof do not extend beyond the front and rear surfaces of the flat display 200.

For the purpose of fixing each supporting foot 230 in the position where the length direction of the foot 230 is in line with the width direction of the flat display 220 as shown by solid lines in FIG. 17, and in the position where each supporting foot 230 protrudes beyond the front surface or rear surface, indicated by dot-dash lines, of the flat display as indicated by broken lines, a ball 238 is disposed in the interior of the foot 230 and is pressed upward by an elastic member, e.g. a spring 236, as shown in FIG. 18. A portion of the ball 238 is exposed through an opening in the top surface of the supporting foot 230, and rotates when the supporting foot 230 rotates about its associated shaft 234. Also, two recesses 240a and 240b are formed for each foot 230 at such locations on the bottom surface of the mount 232 that the exposed portion of the ball 238 of each foot 230 can enter into the associated recesses 240a and 240b when the foot 230 is in the position where its length direction is in line with the width direction of the flat display 200 and when the foot 230 is in the position where the distal end of the foot 230 is beyond the front or rear surface of the flat display 200, respectively.

When the supporting feet 230 are in the position where they are disposed to extend along the width direction of the flat display 200, the feet 230 extend beyond neither the lateral sides nor front and rear surfaces of the flat display 200. Accordingly, the size of packaging cases for the flat displays 200 with the supporting apparatuses can be kept small.

According to the above-described third embodiment, two supporting feet are used, but, by using shorter feet, more than two supporting feet can be attached. Also, more than four supporting feet may be used in the fourth embodiment. Further, in the fourth embodiment, the proximal end portions of the supporting feet 230 may be interlinked together so that all the supporting feet 230 can be simultaneously moved between the two positions.

What is claimed is:

1. A flat display supporting apparatus comprising:
a main unit formed in the shape of generally rectangular parallelepiped, said main unit having a top surface on which a flat display is adapted to be rested with front and rear surfaces of said flat display being in parallel with opposing two longitudinal surfaces of said main unit, the distance between said two opposing longitudinal surfaces being larger than the thickness of said flat display;
a foldable unit disposed on at least one longitudinal side of said main unit to face at least one of said front and rear surfaces of said flat display, said foldable unit being disposed generally in parallel with said at least one of said front and rear surfaces of said flat display;
projections extending from said main unit in such a manner as to be able to generally contact with opposing lateral sides of said foldable unit;
generally horizontal rotation shafts extending from one of said lateral sides of said foldable unit and said projections toward the other of said lateral sides of said foldable unit and said projections; and
shaft holes formed in said other of said lateral sides of said foldable unit and said projections to receive said rotation shafts in a rotatable manner, said shaft holes including a stop for preventing said foldable unit from forming an angle of substantially greater than ninety degrees with respect to said at least one of said front and rear surfaces of said flat display.

2. The flat display supporting apparatus according to claim 1, wherein each of said rotation shafts has a lower surface extending generally horizontally when said foldable unit is in a position where said foldable unit is generally perpendicular to said at least one of said front and rear surfaces of said flat display; and said stop is formed in said shaft hole in such a manner as to contact with a portion of said lower surface of said rotation shaft.

3. A flat display supporting apparatus comprising:
a main unit formed in the shape of generally rectangular parallelepiped, said main unit having a top surface on which a flat display is adapted to be rested with front and rear surfaces of said flat display being in parallel with opposing two longitudinal surfaces of said main unit, the distance between said two opposing longitudinal surfaces being larger than the thickness of said flat display;
a foldable unit disposed on at least one longitudinal side of said main unit to face at least one of said front and rear surfaces of said flat display, said foldable unit being disposed generally in parallel with said at least one of said front and rear surfaces of said flat display;
projections extending from said main unit in such a manner as to be able to generally contact with opposing lateral sides of said foldable unit;
generally horizontal rotation shafts extending from one of said lateral sides of said foldable unit and said projections toward the other of said lateral sides of said foldable unit and said projections; and
shaft holes formed in said other of said lateral sides of said foldable unit and said projections to receive said rotation shafts in a rotatable manner;
wherein said foldable unit is disposed, being spaced from said main unit; said shaft holes are extended generally horizontally toward said main unit; and an engaging member is provided on said longitudinal surface of said main unit facing said foldable unit, with a retaining member provided on a surface of said foldable unit facing said longitudinal surface of said main unit, said engaging member and said retaining member engaged with each other when said foldable unit in said position where said foldable unit is generally perpendicular to said at least one of said front and rear surfaces of said flat display.

4. The flat display supporting apparatus according to claim 3, wherein said engaging member is an engaging protrusion protruding from one of said longitudinal surfaces of said main unit facing said foldable unit and the surface of said foldable unit facing said longitudinal surface of said main unit toward the other of said longitudinal surfaces of said main unit and said surface of said foldable unit facing said one longitudinal surface of said main unit; and said retaining member is formed in said other longitudinal surface of said main unit and said surface of said foldable unit facing said one longitudinal surface of said main unit and presses and clamps said engaging protrusion.

5. The flat display supporting apparatus according to claim 1, wherein a protrusion is formed in one of said longitudinal surface of said main unit facing said foldable unit and said surface of said foldable unit facing said one longitudinal surface of said main unit, said protrusion protruding toward the other of said one longitudinal surface of said main unit and said surface of said foldable unit facing said one longitudinal surface of said main unit, and an opening is formed in said other of said one longitudinal surface of said main unit and said surface of said foldable unit facing said one longitudinal surface, said protrusion entering into said opening when said foldable unit is moved toward said main unit to cause said one longitudinal surface to contact with said surface of said foldable unit.

6. The flat display supporting apparatus according to claim 3, wherein a protrusion is formed in one of said longitudinal surface of said main unit facing said foldable unit and said surface of said foldable unit facing said one longitudinal surface of said main unit, said protrusion protruding toward the other of said one longitudinal surface of said main unit and said surface of said foldable unit facing said one longitudinal surface of said main unit, and an opening is formed in said other of said one longitudinal surface of said main unit and said surface of said foldable unit facing said one longitudinal surface, said protrusion entering into said opening when said foldable unit is moved toward said main unit to cause said one longitudinal surface to contact with said surface of said foldable unit.

7. A flat display supporting apparatus comprising:
a base unit having a generally rectangular flat surface on which a flat display is adapted to be mounted; and
a pair of feet disposed at respective ones of opposing end portions of said base unit, each of said feet having an intermediate portion thereof mounted to said base unit by a vertical shaft about which said foot is rotatable.

8. The flat display supporting apparatus according to claim 7, wherein said vertical axes are disposed at such locations that the length of those portions of said feet, which protrude beyond opposing ends of said base unit when said feet are disposed in alignment with said base unit, is smaller than the length of those portions of said feet lying underneath said base unit.

9. The flat display supporting apparatus according to claim 7, wherein protrusions are provided on one of said base unit and said feet, with recesses into which said protrusions can enter formed in the other of said base unit and said feet; said protrusions being located on arcs centered about said vertical shafts, said recesses being so located that said protrusions can enter into said recesses when said feet are disposed substantially perpendicular to said base unit.

10. A flat display supporting apparatus comprising:
at least two mounts coupled to a bottom surface of a flat display at locations along a lateral direction of said flat display; and
at least two supporting feet mounted on bottom surfaces of said respective mounts in such a manner as to be rotatable about shafts extending in a height direction of said flat display, each of said feet having a length dimension equal to or smaller than one-half of a lateral dimension of said flat display and equal to or greater than a depth dimension of said flat display, and having a predetermined width dimension equal to or smaller than said depth dimension of said flat display.

11. The flat display supporting apparatus according to claim 10, wherein said supporting feet have rotation limiting means limiting the rotation of said supporting feet in a range between a position where a length direction of said feet is in alignment with a lateral direction of said flat display and a position where the length direction of said feet is along a depth direction of said flat display.

12. A flat display supporting apparatus comprising:
a mount coupled to a bottom surface of a flat display; and
at least two sets of supporting feet, each set consisting of two or more supporting feet, each set being mounted to a bottom surface of said mount on respective sides of a laterally mid portion of said mount in such a manner as to be rotatable about respective shafts extending in a height direction of said flat display, each of said supporting feet having a length dimension equal to or smaller than one-half of a lateral dimension of said flat display and larger than a depth dimension of said flat display, and having a predetermined width dimension equal to or smaller than said depth dimension of said flat display.
